(19) United States
(12) Patent Application Publication
(10) Pub. No.: US 2016/0140331 A1
(43) Pub. Date: May 19, 2016

(54) Method and system for biometric identification and verification

(71) Applicant: Michael Geronimo Perez, Birmingham, AL (US)

(72) Inventor: Michael Geronimo Perez, Birmingham, AL (US)

(21) Appl. No.: 14/155,394

(22) Filed: Jan. 15, 2014

(51) Int. Cl. G06F 21/32; G06F 21/45

(52) U.S. Cl. CPC G06F 21/32; G06F 21/45

(57) ABSTRACT

Financial entities and other organizations that have customers who set up accounts with the entity are at risk of having people set up multiple accounts at different branches of an entity or at different entities and their different branches. Many of these accounts will be set up under different names and may use false identities. A single customer, often a Money Mule, will then have multiple accounts across multiple branches of multiple entities and will use the multiple accounts to facilitate the illegal transfer of funds from the customer accounts of the entity. The entities have no way of knowing that the person has set up multiple accounts under the same name or multiple accounts under various identities and is thus not equipped to prevent cybercrimes that use those multiple accounts. Using the biometric identification system and method described in this invention disclosure solves that problem for the participating entities.

### RELATED U.S. APPLICATION DATA

This application claims the benefit of filing priority under 35 U.S.C. §119 from provisional patent application ser. No. 61/752,926 entitled A METHOD AND SYSTEM FOR BIOMETRIC IDENTIFICATION AND VERIFICATION. All information disclosed in that prior application is incorporated herein by reference.

### FIELD OF INVENTION

The presentation relates generally to the prevention of identity fraud in connection with fraudulent activities. In greater particularity, the invention relates to methods for detecting when an individual's biometric identifier and associated information, do not match with identity information previously associated with that biometric identifier. By using the biometric identifier in connection with previously associated identification information, i.e., name, photograph, race, gender, etc., the method and system of the invention can detect and provide notification of the mismatch and can prevent or deter fraudulent activities associated with the attempted identity fraud.

### BACKGROUND OF THE INVENTION

Financial cybercrime is a significant and growing problem for financial institutions and their customers and for any entity from which funds can be transferred. Cybercriminals are successful in using phishing and malware-based strategies and actions and insiders and social engineering to gain information and/or access that allows them to illegally transfer funds from the accounts of customers and financial institutions and other entities to the accounts of the cybercriminal, the cybercriminal's “money mules”, or to other accounts or to prepaid debit card and similar accounts. Multiple money mule accounts are often held by the same individual using different identities, usually stolen identities, provided by the cybercriminals. These money mule accounts exist for the purpose of receiving illegally transferred funds. Today, although banks and financial institutions are required by various regulatory agencies to have in place customer identification programs (CIP), the institutions have no way of knowing if an individual opens an account at another bank or institution or at another branch of its own, using a different identity. Therefore, the cybercriminals and their money mules gain the advantage of scale by having one money mule with multiple accounts under different names, all the while with the fraud undetected by the banks or financial institutions.

The ability to screen, analyze, and compare new account setups, using biometric-based customer identity profiles, both with the bank's own account base, and for a broader base of accounts with other entities, would allow the banks and other entities to detect false identities at the attempt to set up a second or other subsequent account. The system and method, proposed in this invention disclosure provide a centralized system and database for the collection, storage, analysis, reporting, and distribution of customer identity profiles and matching those profiles with biometric identity information for the purpose of detecting attempts by the same individual to set up different accounts under different identities.

### SUMMARY OF INVENTION

The disclosed invention is a system and method for automatically detecting and identifying mismatches between one set of stored biometric identification information, in this case a palm vein scan, and identification information associated with that stored palm vein scan and, another set of biometric identification information and the identification information associated with this second or subsequent biometric identifier. At an initial account set up, the individual requesting the account would provide identity information that is associated with that individual and with the new account. The individual also would have a biometric identification made, in this case, a palm vein scan, and the biometric identifier would be associated in the system database with that individual and with the identification information provided. A photograph of the individual could be made and the digitized photograph could be stored along with the biometric identification and other information obtained at the account setup session. When the same individual attempts to set up another account, the same process is followed, gathering identification information and also creating a biometric identifier by taking a palm vein scan that is associated with the individual and the information provided in the subsequent account setup attempt. Another photograph of the individual could be made and the digitized photograph could be stored along with the biometric identification and other information obtained at the subsequent account setup session. The system and method of the invention would then would be used to search the system database to find an existing match for the palm vein scan. When a match is found, if all of the other identifying information is the same, then the account setup process continues normally. If the information associated with the original palm vein scan is different from the information associated with the same palm vein image, the one provided in the subsequent account set up, the system will mark the biometric image and the stored identification information to indicate the discrepancy ant potentially fraudulent activity associated with the individual whose biometric identifier had been used in both or more account set ups. The system would also provide alerts to the system users of possible fraudulent activity. By providing the users of the system with information about potentially fraudulent account setups, the system will help those users prevent or deter cybercrimes associated with those fraudulent accounts, accounts that without the method and system provided by this invention would have been set up undetected by the entity. Another benefit of the this invention is that the customer biometric information ands associated images and other information obtained under the account setup process will be 100% reusable for ATM identification/verification at whatever time the institution wishes to implement such a program.

Significantly, this invention is not used to validate that a given individual is who they purport to be, as in the case of a 1:1 verification, but rather is used to create an alert when the same information, in this case, the biometric palm scan, is associated with different information, indicating that there either are discrepancies in the information or there is an intent to defraud by the same individual setting up setting up different accounts under different identities.

This invention does not propose new hardware to scan for biometric information. Such hardware is available from companies like Fujutsi and M2Systems, and others. This invention does not propose a new method of digitizing and analyzing biometric images as the software of the selected hardware vendor, i.e., above, would be used in conjunction with and as part of the System. The novelty of this invention is that it is a computer-based system and method of collecting, storing, analyzing, reporting, and sharing information to combat financial crimes that involve an individual or individuals setting up multiple accounts, at branches of the same institution or across different institutions, under multiple identities, one or more of those identities possibly being false. This system allows banks and other institution to access a centralized database to determine, based on software programs that works beyond just the biometric programs already available, attempts by an individual to use different identities up set up multiple accounts. Once an individual has been identified as a suspect for setting up fraudulent accounts, the system will alert all clients, including law enforcement as needed, about the suspect and the suspect alternate identities so that those entities will be alerted to potential criminal acts. This capability does not now exist for these entities to effectively fight cybercrime.

### BRIEF DESCRIPTION OF THE DRAWINGS

An apparatus for effectively identifying, analyzing, and reporting fraudulent attempts to set up financial accounts that can then be used in financial crimes is depicted in the attached drawings which form a portion of the disclosure and wherein:

FIG. 1 is a process flow diagram of part of the preferred embodiment of the invention;

FIG. 1A is a continuation of the process flow started on FIG. 1;

FIG. 1B is a continuation of the process flow on FIG. 1A;

FIG. 2 is a process flow diagram of another part of the preferred embodiment of the invention, The Digital Photo process.

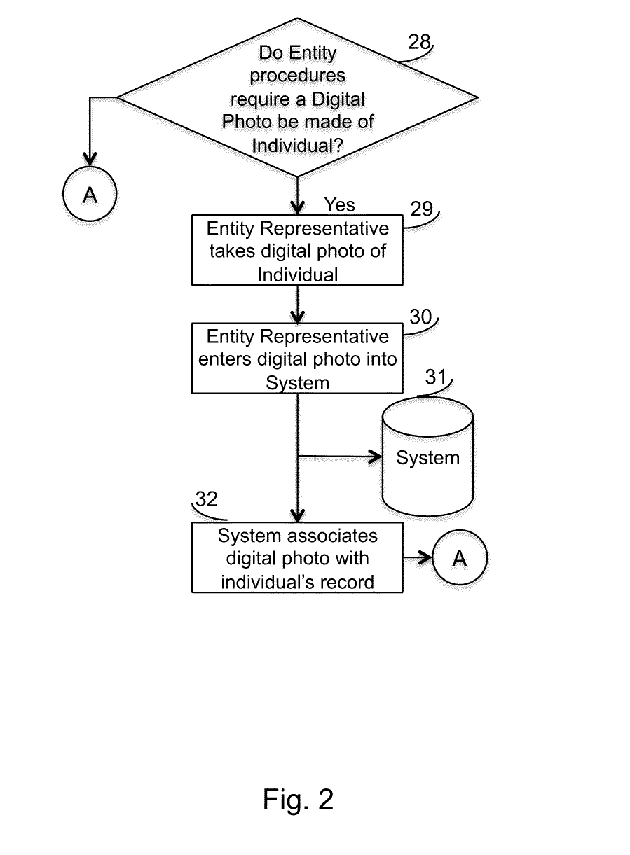

FIG. 3 is a high-level architecture and data flow diagram incorporating the main elements of the disclosed system.

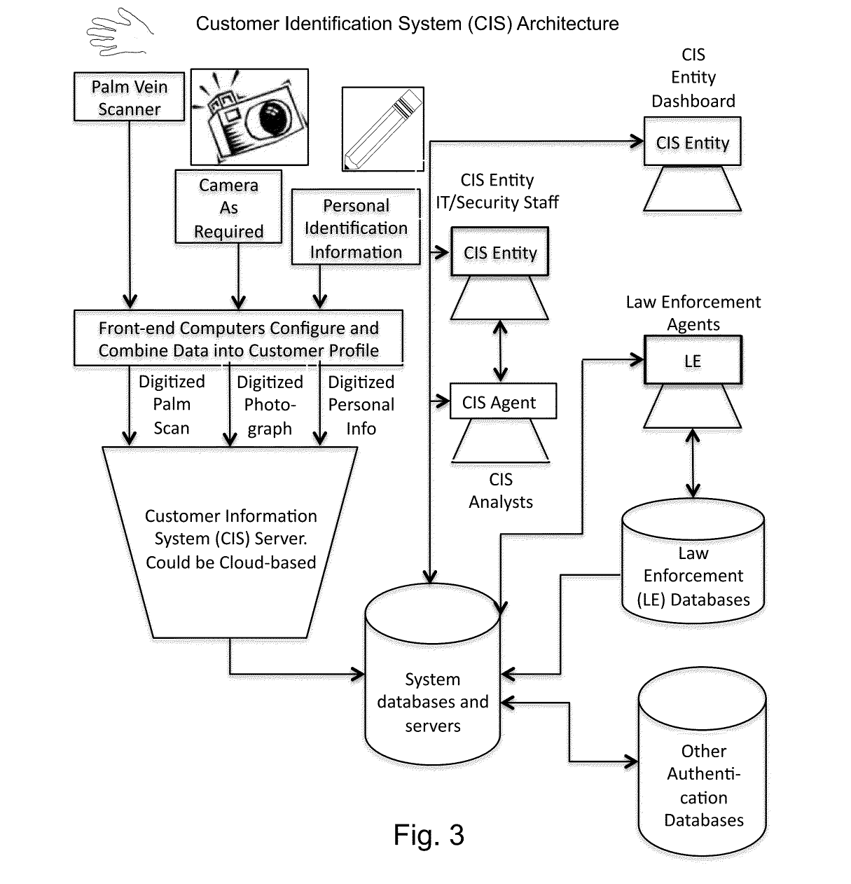

### DESCRIPTION OF THE PREFERRED EMBODIMENTS

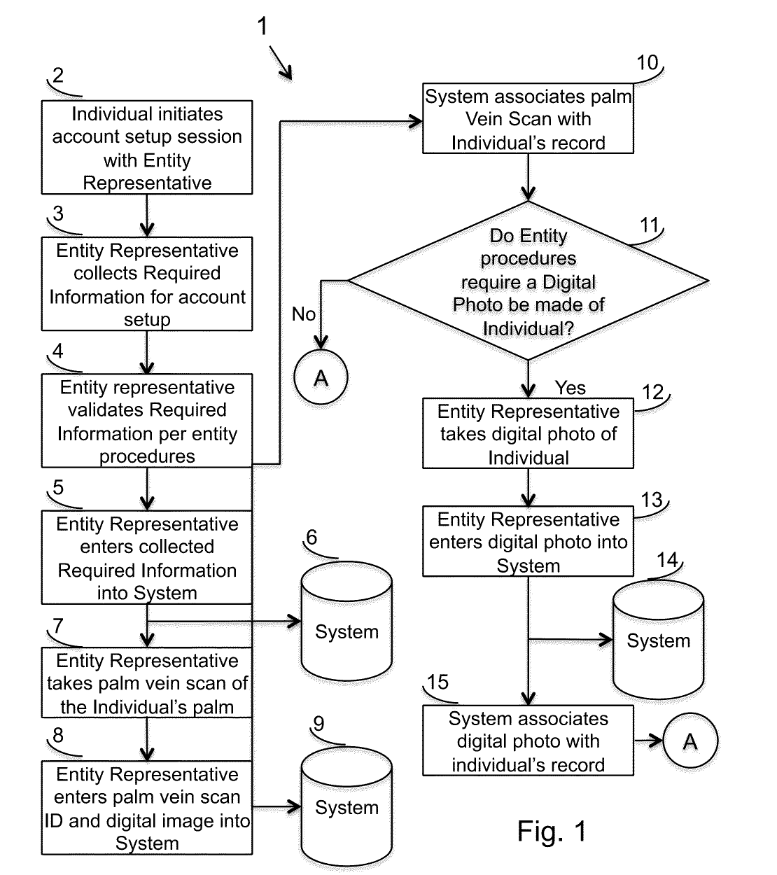

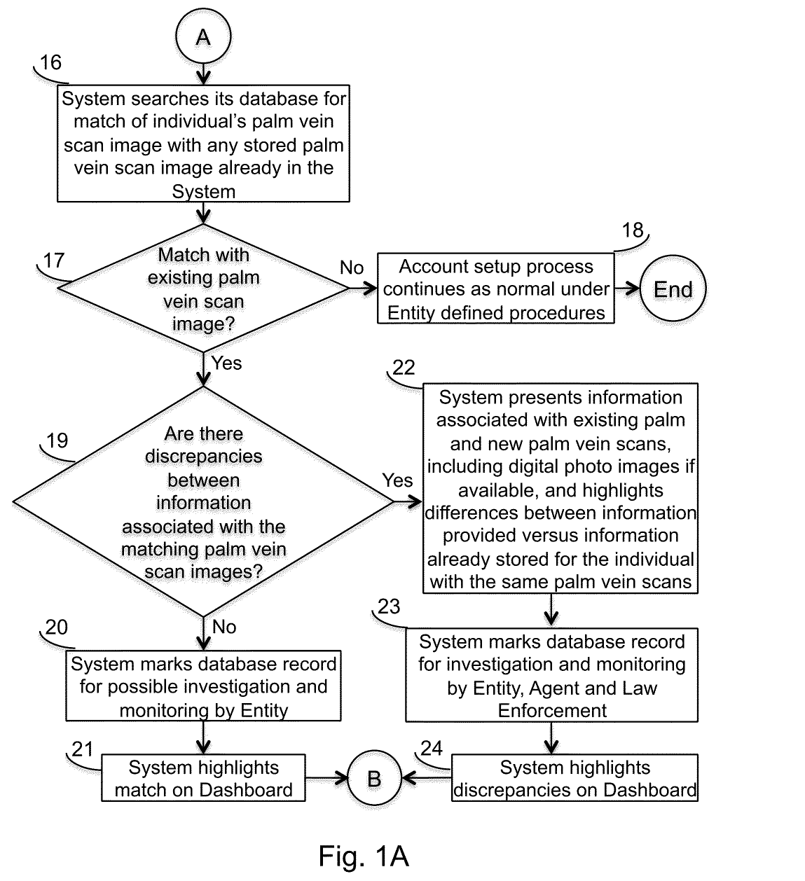

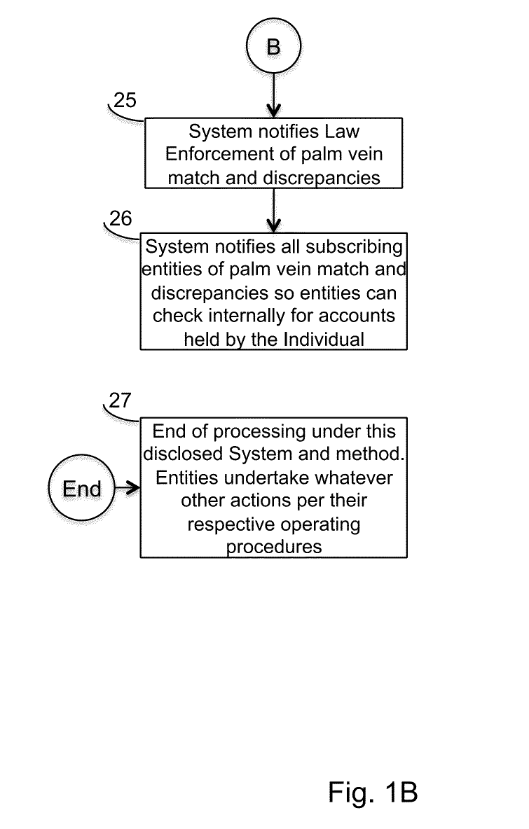

Referring to FIG. 1, the system 1 is constructed to run on a computer system, such as a computer server having a modern operating system like Microsoft Windows or a variant of UNIX such as Linux. It is anticipated that the system would run on a Linux OS derivative, Cent OS, offered by Red Hat. It is anticipated that database functionality would be provided by PostgresSQL, which is a powerful open source object-relational database system. It is anticipated that PERL initially would be used in the system to control communications through the Internet and to parse received data. It is anticipated that a compiled language such as C would ultimately be used to implement the features of the system. Software for collecting palm vein scans and for comparing stored images of palm vein scans would be that software already commercially available and obtained from the palm vein scan equipment supplier such as Fujutsi or M2Systems, or others.

Upon initiation 2 an Individual initiates an account setup session with the Entity Representative of the financial entity or organization. The Entity Representative collects 3 the Required Information from the set or documentary information, nondocumentary information, and Personally Identifiable Information (PII) from and about the Individual.

The Entity Representative validates 4 the Required Information using the processes designated by that Entity's procedures. After validating the information, the Entity Representative enters 5 the collected Required Information into the System 6.

The Entity Representative then takes a palm vein scan 7 of the individuals hand and enters 8 the palm vein scan Id (right or left palm) and digital image into the System 9. Typically the palm vein scan will be of the Individual's right palm but may be made of the left palm if it is apparent that the right palm cannot be used successfully for the scan. The System associates 10 the palm vein scan digital image with the Individual's record.

If Entity procedures 11 do not require a digital photograph to be made of the Individual, the process continues to A in FIG. 1A. If Entity procedures 11 require a digital photo to be made of the Individual, the Entity Representative takes 12 a digital photo of the individual. The Entity Representative enters 13 the digital photo into the System 14 and the System associates 15 the digital photo with the Individual's record.

Once the data has been collected and entered into the System, the System searches 16 its database for match of individual's palm vein scan image with any stored palm vein scan image already in the System. If there is not a match 17 with an existing palm vein scan image, the account setup process continues 18 as normal under the Entity's defined procedures and that ends FIG. 1B 27 the processing covered by this invention disclosure.

If there is a match 17 with an existing palm vein scan image in the System, the

System checks 19 for discrepancies between information associated with the matching palm vein scan images. That is the newly stored palm vein scan image for the Individual and a previously stored palm vein scan image that matches the newly stored palm vein scan image. If no discrepancies are found between the information and data associated with the newly stored palm vein scan image and the information and data associated with the previously stored palm vein scan image, the System marks 20 the Individuals database record for possible investigation and monitoring by Entity as there still may be suspect activity involved in the Individual's opening multiple accounts, even though he or she uses the same identifying credentials. The System highlights 21 the match on the Dashboard, typically a commercially available product that interfaces with the System using standard Application Program Interfaces (API).

If when the System checks 19 for discrepancies between information associated with the matching palm vein scan images and finds that there are discrepancies, the System presents 22 information associated with existing palm and new palm vein scans, including digital photo images if available, and highlights differences between information provided versus information already stored for the individual with the same palm vein scan images. The System marks 23 the database record for investigation and monitoring by Entity, Agent and Law Enforcement database record for investigation and monitoring by the Entity, the Agent and by Law Enforcement. The System highlights 24 the discrepancies on the Dashboard. The process continues at FIG. 1B B.

The System/Agent notifies 25 Law Enforcement of the palm vein match and discrepancies in the associated information.

System notifies 26 all subscribing Entities of the palm vein match and discrepancies so Entities can check internally for accounts held by the Individual and investigate those accounts as determined by the Entity's procedures.

The processing covered by this invention disclosure ends 27.

### REFERENCES CITED

8,111,878 Vein authentication device and vein authentication method

8,229,179 Finger vein authentication apparatus and finger vein authentication method

JP2006218019 (A)—Vein image acquiring apparatus, biological image acquiring device, and personal authentication system using the same

M2-PalmVein™ palm vein scanner: http://www.m2sys.com/palm-vein-reader.htm?gclid=CJSKjI7d1LQCFQeynQodOHoA-g Fujutsi's PalmSecure Product: http://www.fujitsu.com/us/services/biometrics/palm-vein/

Having set forth the nature of the invention, what is claimed is:

1. A method for identification, verification, storage, analysis and sharing of biometric information and other information related to setting up accounts, facilitating the detection of attempts to set up fraudulent accounts, comprising the steps of:
a. an Individual initiating an account setup session at an Entity with an Entity Representative;
b. said Entity Representative collecting Required Information for setting up said account;
c. said Entity Representative validating said Required Information per said Entity's procedures;
d. said Entity Representative entering said collected Required Information into the System;
e. said Entity Representative taking a palm vein scan of said Individual's right-hand palm if possible or left-hand palm if necessary;
f. said Entity Representative entering the palm vein scan ID (right hand palm or left hand palm) and digital image into said System;
g. said System associating said palm Vein Scan with said Individual's record in said System;
h. said System searching its database for a match of said Individual's palm vein scan image with any stored palm vein scan image already in said System;
i. finding no matches, said System indicating no matches found and said account setup process continuing normally under said Entity's own processes;
j. finding matches, said System checking for discrepancies between the information associated with said newly stored said palm vein scan image and information associated with a previously stored, but matching, palm vein scan image;
k. said System presenting information associated with said previously stored palm vein scan image and said newly stored palm vein scan image, including digital photo images if available, and highlighting differences between information provided by said Individual and information already stored for the individual with the matching said previously stored palm vein scan image;
l. said System marking said database record for investigation and monitoring by said Entity, Agent and Law Enforcement;
m. said System highlighting discrepancies on the Dashboard;
n. said System notifying said Law Enforcement of said palm vein match and said discrepancies;
o. said System notifying all subscribing Entities of said palm vein match and said discrepancies so said entities can check internally for other accounts held by said Individual and monitoring or investigating said other accounts.

2. The method as recited in claim 1 wherein said step collecting said Required information requires the Entity to make a digital photo of said Individual comprising the steps of:
p. said Entity Representative taking a digital photo of said Individual:
q. said Entity Representative entering said digital photo into said System;
r. said System associating said digital photo with said Individual's record in said System enabling the use of said photo in comparing information about said Individual with other photos associated with other stored palm vein scan images that when compared, match said Individual's said newly stored palm vein scan image.
